(19) United States
(12) Patent Application Publication
(10) Pub. No.: US 2005/0140968 A1
(43) Pub. Date: Jun. 30, 2005

(54) Collimating detection apparatus and optical module packaging apparatus using the same

(76) Inventors: Sang Kyun Lee, Gwangju-Shi (KR); Heang Suk Oh, Daejeon-Shi (KR); Jai Sang Koh, Gwangju-Shi (KR)

Correspondence Address: JACOBSON HOLMAN PLLC, 400 SEVENTH STREET N.W., SUITE 600, WASHINGTON, DC, 20004, US

(21) Appl. No.: 10/923,819

(22) Filed: Aug. 24, 2004

(30) Foreign Application Priority Data
Dec. 24, 2003 (KR) 2003-96044

(51) Int. Cl. H01S 3/08; G02B 6/10; G01B 11/26

(52) U.S. Cl. 356/153

(57) ABSTRACT

Provided is a collimating detection device for use in fabricating a semiconductor laser diode module, wherein the collimating detection apparatus discriminates using a light output difference between a case where the beam emitted from a laser diode becomes parallel light through a collimating lens and a case where the parallel light is not made, using properties of Fabry-Perot etalon that changes optical power of the output beam as an angle of an incident beam is changed.

### BACKGROUND

1. Field of the Invention

The present invention relates to a collimating detection apparatus and an optical module packaging apparatus using the same, wherein the collimating detection apparatus discriminates a light output difference between a case where the beam emitted from a laser diode becomes parallel light through a collimating lens and a case where the parallel light is not made, using a feature of a Fabry-Perot etalon that changes optical power of the output beam as an angle of the incident beam is changed. That is, the present invention relates to an alignment apparatus for aligning and attaching the collimating lens mounted on a laser diode submodule to an exact place, in fabricating a semiconductor laser diode module for high-speed optical communication with an optical fiber.

2. Discussion of Related Art

Generally, factors that should be considered in packaging a semiconductor laser diode module used for high-speed optical communication are that laser diode properties such as a light output and a single mode operation should not be degraded, and that most of the laser light output should be transmitted to an optical fiber. For this, optical, electrical, thermal, and mechanical aspects should be carefully taken into account. Regarding an optical aspect of the semiconductor laser diode module packaging, high coupling efficiency between the laser diode and the optical fiber should be obtained to maintain an average light output required for the system. Further, an optical feedback that gives a bad effect on the stabilized single mode operation of the laser diode must be blocked. Regarding a mechanical aspect for achieving reliability, a module design and fabrication process should be developed so that the optical alignment of the assembled optical components is not be changed by the extreme environment change.

FIG. 1A is a plan view of a typical laser diode module for high-speed optical communication that is currently and mainly fabricated on the basis of the foregoing consideration, and FIG. 1B is a side view of the laser diode module shown in FIG. 1A, and FIG. 1C is a side view of a laser submodule of the laser diode module shown in FIG. 1A. Referring to FIGS. 1A to 1C, a typical configuration of the semiconductor laser diode module will be briefly described as follows.

First, as shown in FIG. 1C, a submodule 50 is fabricated comprising a laser diode 1, a heat dissipation substrate 2, a monitor diode 3, a chip carrier 5, a L-shaped lens fixture 6, a collimating lens 4, a lens housing 16 and a lens ring 17. For fabricating the submodule 50, the laser diode 1 is attached over the diamond-based heat dissipation substrate 2, and is assembled on the chip carriers together with the components such as the monitor diode 3.

Here, the total thickness of the heat dissipation substrate 2 and the chip carrier 5 is formed such that the height of the laser diode 1 matches with the centers of a optical isolator 9 and a base ring 10, when attaching the laser diode 1 and then using this to insert the laser diode 1 in a module as shown in FIG. 1B. To attach the lens 4 using a laser welding process, this chip carrier 5 is fixed on the L-shaped lens fixture 6 so that the laser diode 1 is located on the center of a hole of the lens fixture 6, using epoxy or solder with good heat conductivity. And then, with a concentric axis of both an optical fiber ferrule 11 and the lens housing 16 where the lens 4 is inserted, and using laser welding equipment to change a distance between the lens 4 and the optical fiber ferrule 11 and a distance between the lens 4 and the laser diode 1, when an optimal condition is obtained by alignment in a vertical direction and a horizontal direction, 3 spot of YAG laser beam for welding are simultaneously injected at an angle of 120° to portions 18 and 19 to be welded and the lens 4 is fixed to the lens fixtures 6, so that the submodule 50 is completed.

Next, in order to fabricate the laser diode module, a thermoelectric cooling device 7 is fixed on the bottom of a butterfly package 13 by a soldering method, and thermo-conductive epoxy is added onto the thermoelectric cooling device 7, and then the submodule 50 fabricated above is put on and fixed, as shown in FIG. 1B. In a butterfly package 13 prepared like this, a optical isolator 9 is inserted, and then the base ring 10 is again welded to the laser welding portion 20 using the laser welding equipment, and the optical fiber ferrule 11 is fixed by laser welding on this base ring 10 using the ferrule housing 12 Here, the fine alignment for the laser welding is conducted until the light emitted by driving the laser diode electrically is focused with the maximum power on the optical fiber 23, and then, a welding process 21 in the vertical direction 21 is performed to prevent the degradation of the light coupling efficiency due to the displacement after welding. Next, an optical fiber protective film 14 is screwed into a screw groove 15 of the base ring 10, and a module lid 24 is covered, and thus, the laser module is completed.

In fabricating the laser diode module, the inner diameter and the outer diameter of the base ring 10 are formed as small as possible considering the module miniaturization and the specification of the components used in the laser welding, and the optical fiber ferrule 11 is designed to be placed inside of the surface of the base ring 10, as shown in FIGS. 1A and 1B, for the components stability and the module miniaturization in fixing the optical fiber ferrule 11. However, although the optical fiber ferrule 11 was designed to be placed outside of the surface of the base ring 10 without considering the module miniaturization, it may happen that the base ring 11 is placed inside in aligning the light in the axis direction.

However, there is not enough room between the inner diameter of the base ring 10 and the outer diameter of the optical fiber ferrule 11, so that, when the complete submodule 50 is fixed to the thermoelectric cooling device 7, if the optical axis passed through the laser diode 1 and the collimating lens 4 is significantly deviated from the center of the base ring 10 (more than 500 μm), the position for the maximum light coupling is deviated from the base ring 10, and the outer surface of the optical fiber ferrule 11 is bumped into the inner surface of the base ring 10, so that the optical alignment cannot be conducted any more, resulting in the failure of fabricating the optical laser module. Further, unfortunately, if the optical axis of the optical fiber ferrule 11 and the submodule 50 are unmatched, the coupling efficiency of the light focused onto the optical fiber 23 is degraded.

While performing the existing module assembly process, a factor that should be kept in mind in fixing the submodule 50 to the thermoelectric cooling device 7 is that the process difficulty should be considered in fixing the submodule 50, followed by inserting a optical isolator 9 and fixing the base ring 10 by the laser welding, and then, fixing the optical fiber ferrule 11.

In the conventional laser diode module assembly process, the height was matched to the center of a optical isolator 9 and the chip carrier 5 and the butterfly package 13 were aligned to match the right and left centers using a microscope, through an exact design and the components fabrication for the thermoelectric cooling device 7, the heat dissipation substrate 2, the chip carrier 5 and the laser diode 1, in order to match the optical axis 43 to the center of a optical isolator 9 and the base ring 10.

In the conventional aligning method, a first problem is that the alignment of the right and left of the laser submodule 50 is conducted by the microscope, however, it depends on the determination of an operator who makes an observation through the microscope, so that the accuracy cannot exceed the limit of the human perception. Secondly, in aligning the top and bottom of the laser submodule 50, although the height is matched to the center of a optical isolator 9 through the precise design and the components fabrication for the thermoelectric cooling device 7, the heat dissipation substrate 2, the chip carrier 5 and the laser diode 1, there is a limit in the fabrication tolerance of these components, and also, an additional error can be generated due to the use of a solder, a thermo-conductive resin, an electric conductive resin, etc. used with a certain amount in fixing the components.

In fact, in fabricating the module, the distance between the submodule 50 and the optical fiber ferrule 11 is about 6 to 7 mm, which is relatively apart, so that the optical axis at a place where the optical fiber ferrule 11 is located can be easily deviated more than 500 μm from the center of the base ring 10 when the submodule 50 is deviated from the optical axis 43 due to this little error. In this case, if the components is assembled without any correction, the base ring 10 and the optical fiber ferrule 11 are bumped in aligning the optical fiber ferrule 11, as described above, so that there is increased the chances to fail in assembling the module as well as the light coupling efficiency focused onto the optical fiber 23 is reduced since the optical axis of the submodule 50 and the optical axis of the optical fiber ferrule 11 are not matched.

FIG. 2A and FIG. 2B are overall configuration diagrams of a beam aligning apparatus of a semiconductor laser module according to the prior art where a laser submodule is mounted. Such beam aligning apparatus is disclosed in Korean Patent No. 0226444.

The beam aligning apparatus of the semiconductor laser module according to the prior art is composed of a submodule holder stage constructed on the beam aligning apparatus support 42, and for moving a submodule holder 45 to align the submodule in the x, y, and z directions; a hot plate 31 for thermosetting a thermo-conductive epoxy between the submodule 50 and the thermoelectric cooling device after the alignment is made and fixing the submodule 50 to the thermoelectric cooling device; a beam aligning tube 37 where one end is inserted into the insertion groove 44 of a optical isolator of the butterfly package, and converting the beam emitted from the laser diode of the submodule 50 into the parallel light to be focused onto a screen 39; a x, y, z-stage 32 for fixing the beam aligning tube 37 and moving in x, y, and z directions, and the screen 39 and an infrared camera 40 for observing the aligned beam during the alignment of the submodule 50.

Here, the beam aligning apparatus comprises the beam aligning tube 37, and a lens guide 33 having a cylindrical shape and where a slot 35 for guiding a lens adjusting knob 36 is formed; a collimating lens 34 constructed in the lens guide 33 and converting the beam emitted from the laser diode of the submodule 50 into the parallel light; a lens housing 47 constructed in the upper and lower portions of the collimating lens 34, and passing the beam to the center of the collimating lens 34; and the lens adjusting knob 36 for moving the lens 34 to the right and left within the slot 35 of the lens guide 33, and placing the collimating lens 34 back to the beam waist.

However, according to the prior art as described above, the beam should be manually aligned, so that there is a problem of degrading reliability due to the dependency of the operator determination. Therefore, a new method is required to automatically detect the collimating beam.

### SUMMARY OF THE INVENTION

The present invention is contrived to address the foregoing problems. According to a preferred embodiment of the present invention, a lens position where a beam emitted from a collimating lens is converted into parallel light can be found with an automated optical alignment method, and when the lens conducts the light alignment with the beam aligning apparatus matching to the center axis of the window, the degree of the light axis deviation is reduced relative to fabricating the optical module with the above method, thus leading to increasing the light coupling efficiency.

One aspect of the present invention is to provide a collimating detection apparatus for use in fabricating a laser diode comprising: a Fabry-Perot etalon that changes output power of output light as an incident angle of light emitting from the laser diode is changed; and a light detector that detects a difference of a light output come out of the Fabry-Perot etalon.

Another aspect of the present invention is to provide an optical module packaging apparatus using a collimating detection apparatus, comprising: a laser diode that generates laser light; a lens that transmits light emitted from the laser diode; a Fabry-Perot etalon that changes optical power of output light as an incident angle of the light transmitted from the lens is changed; and a light detector that detects a difference of a light output come out of the Fabry-Perot etalon.

Meanwhile, it can be determined whether a beam emitted from the lens is collimated, using a change of a transmittance according to a full width at half maximum (FWHM) of a far-field pattern of the input light.

### BRIEF DESCRIPTION OF THE DRAWINGS

FIG. 1A is a plan view of a laser module for a high-speed optical communication according to the prior art, and FIG. 1B is a side view of the laser module shown in FIG. 1A, and FIG. 1C is a side view of a laser submodule of the laser module shown in FIG. 1A.

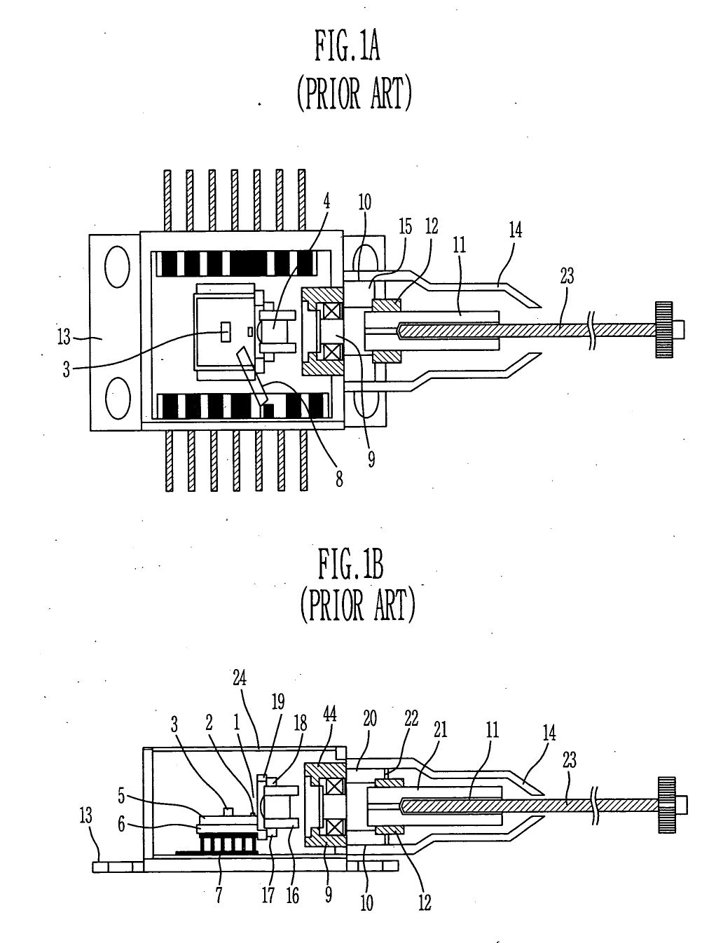

FIG. 2A and FIG. 2B are overall configuration diagrams of a beam alignment apparatus of a semiconductor laser module according to the prior art, where the laser submodule is mounted.

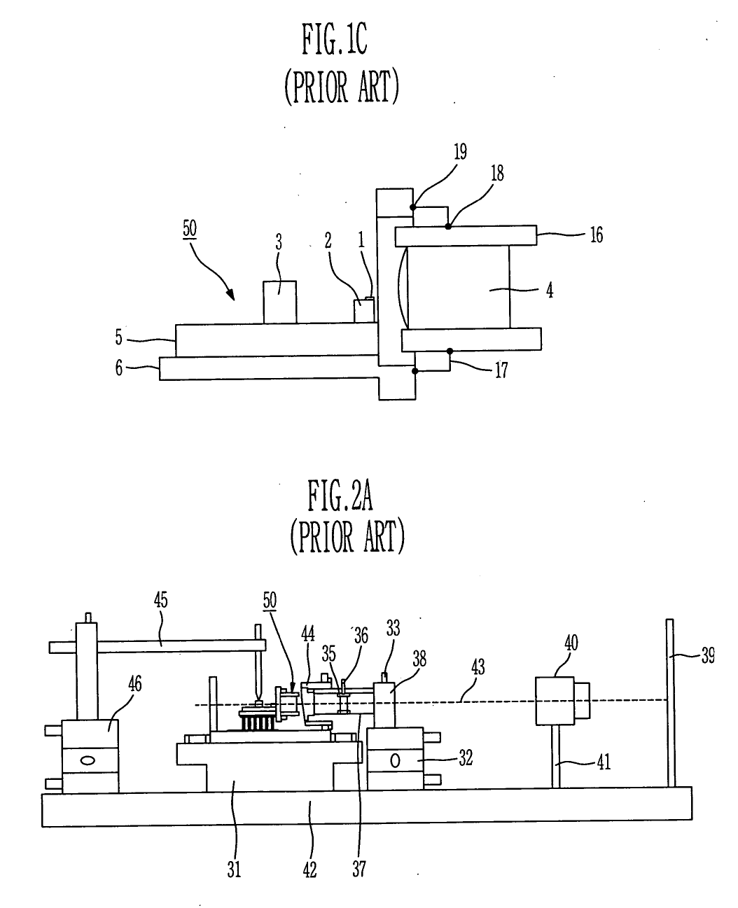

FIG. 3 is a schematic configuration diagram of a collimating detection apparatus according to an embodiment of the present invention.

FIG. 4 is a configuration diagram of an example of an optical module fabricated by the collimating detection apparatus of FIG. 3.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

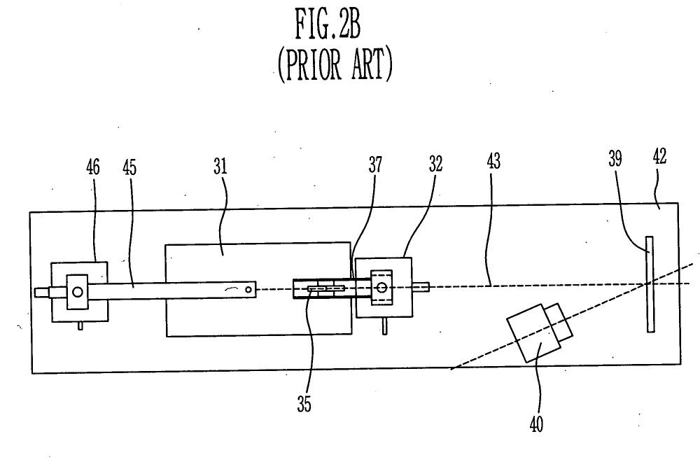

FIG. 3 is a schematic configuration diagram of a collimating detection apparatus according to an embodiment of the present invention.

Referring to FIG. 3, the collimating detection apparatus according to an embodiment of the present invention is composed of a Fabry-Perot etalon 100 and a light detector 101.

As an incident angle of the light emitted from a laser diode (not shown) is changed, the Fabry-Perot etalon 100 changes the optical power of the output light, which allows determining whether the beam emitted from the lens is collimated using a transmittance change according to the incident angle of the light that is incident onto the Fabry-Perot etalon 100.

Preferably, it can be determined whether the beam emitted from the lens is collimated, using a transmittance change according to a full width at half maximum (FWHM) of a far-field pattern of the incident light.

The Fabry-Perot etalon 100 will now be described in more detail.

The transmittance that passes through a Fabry-Perot interferometer is expressed as the following equation 1.

$$T = \frac{( 1 - {R}^{2} )}{( 1 - {R}^{2} ) + 4 R {sin}^{2} ( \frac{2 π L n cos θ}{{λ}_{vac}} )} \qquad ( 1 )$$

where, R indicates a reflection ratio of a mirror located both sides of the interferometer, n indicates a refractive index of medium between mirrors, L indicates an interval between the mirrors, and θ indicates a incident beam angle to a direction perpendicular to the plane of the interferometer. Through the above equation 1, it can be found that the transmittance of the interferometer is a function of an angle.

Using the equation 1 where the transmittance of the Fabry-Perot interferometer is given as a function of an incident angle, when the beam emitted from the laser diode is collimated by a lens, in the case of the collimated beam, the beam is incident substantially perpendicular to the plane of the interferometer, while in the case of the non-collimated beam, the beam is incident in a certain degree. Since the transmittance is changed by a function of this angle, the transmitted beam can be detected using a light detector, thus providing a determination ground for the collimated beam.

Meanwhile, the Fabry-Perot etalon refers to the case where the interval between the mirrors located both sides of the Fabry-Perot interferometer remains constant. That is, the interval remains unchanged by keeping L constant in the above equation 1.

There can be various kinds of light detectors 101, which are not specifically limited. For example, a large-area PIN photodiode with good detection capability can be employed.

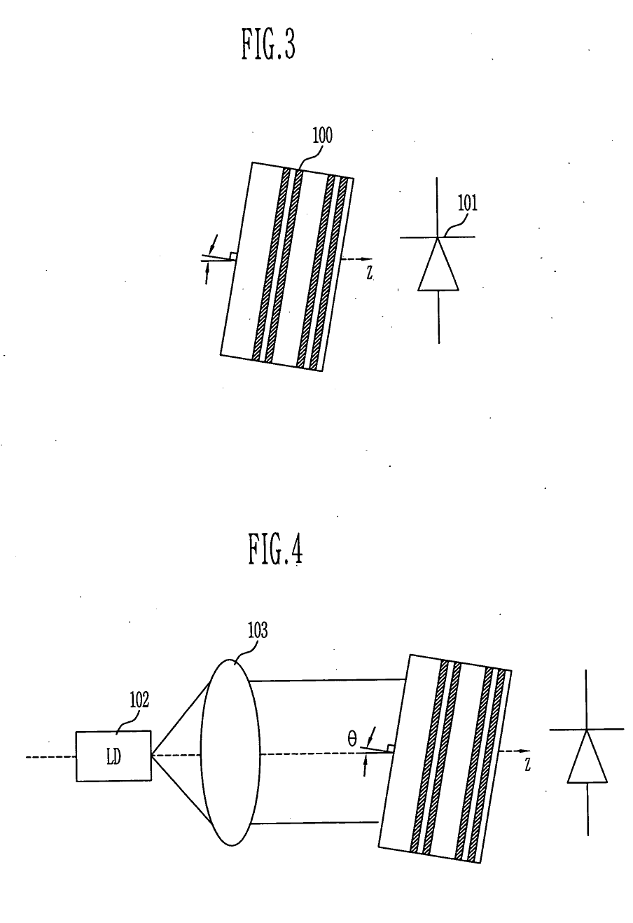

FIG. 4 is a configuration diagram of an example of the optical module fabricated using the foregoing collimating detection apparatus. The collimating detection apparatus comprises the Fabry-Perot etalon 100 and the light detector 101, and moves the lens 103 when collimating the laser beam emitted from the laser diode 102 using the lens 103.

The Fabry-Perot etalon 100 serves to change the optical power of the output light as the incident angle of the light emitted through the lens 103 is changed, and using a transmittance change according to the incident angle of the light that is incident onto the Fabry-Perot etalon 100, it can determine whether the beam emitted from the lens is collimated.

Meanwhile, the lens can be automatically aligned in the automatic alignment apparatus, using a predetermined signal that outputs from the light detector 101.

A variety of modifications of the present invention can be made without departing from the spirit and the scope of the present invention. Therefore, the above description according to the embodiments of the present invention has been provided just for illustrative purpose, and not for restrictive one that limits the present invention, which is just defined by the appended claims and its equivalents.

As described above, the present invention may obtain an exact collimating beam compared to the conventional method of manually aligning a beam using a beam profiler or an infrared camera, and thus, advantageously, the present invention that automatically detects the collimating beam gives the enhanced reliability over the conventional method that is conducted by the determination of the operator.

Further, according to the present invention, the exact collimating beam can be obtained, thus finally, increasing the beam power focused to the optical fiber to enhance the light coupling efficiency.

1. A collimating detection apparatus for use in fabricating a laser diode comprising:
a Fabry-Perot etalon that changes optical power of output light as an incident angle of light emitted from the laser diode is changed; and
a light detector that detects a difference of a light output come out of the Fabry-Perot etalon.

2. The collimating detection apparatus according to claim 1, wherein the collimating detection apparatus determines whether the light is collimated, using a transmittance change according to a full width at half maximum (FWHM) value of a far-field pattern of the input light

3. The collimating detection apparatus according to claim 1, wherein the light detector is a PIN diode.

4. An optical module packaging apparatus using a collimating detection apparatus, comprising:
a laser diode that generates laser light;
a lens that transmits light emitted from the laser diode;
a Fabry-Perot etalon that changes optical power of output light as an incident angle of the light transmitted from the lens is changed; and
a light detector that detects a difference of a light output come out of the Fabry-Perot etalon.

5. The optical module packaging apparatus according to claim 4, wherein the optical module packaging apparatus determines whether a beam emitted from the lens is collimated, using a transmittance change according to a full width at half maximum (FWHM) of a far-field pattern of the input light.
